(19) United States
(12) Patent Application Publication
(10) Pub. No.: US 2023/0322237 A1
(43) Pub. Date: Oct. 12, 2023

(54) Computer-Implemented Method for Training an Articial Intelligence Module to Determine a Tire Type of a Motor Vehicle

(71) Applicant: Robert Bosch GmbH, Stuttgart (DE)

(72) Inventor: Julio Borges, Stuttgart (DE)

(21) Appl. No.: 18/042,262

(22) PCT Filed: Jul. 21, 2021
(86) PCT No.: PCT/EP2021/070526

§ 371 Date: Feb. 20, 2023

(30) Foreign Application Priority Data
Aug. 28, 2020 (DE) 10 2020 210 888.9

(51) Int. Cl. B60W 40/12

(52) U.S. Cl. CPC B60W 40/12; B60W 2520/28; B60W 2422/70

(57) ABSTRACT

A computer-implemented method for training an artificial intelligence module to determine a tire type of a motor vehicle is disclosed. The method includes providing a measured value dataset on a data carrier, wherein the measured value dataset contains at least one data entry regarding ultrasound data, speed data and tire data, wherein the ultrasound data describe at least one ultrasonic wave that was produced by rolling of a tire of the motor vehicle, wherein the speed data describe a speed of the motor vehicle, wherein the tire data describe a tire type of the motor vehicle. The method further includes generating a modified training dataset based on the measured value dataset. Generating the modified training dataset includes (i) forming an input dataset based on the ultrasound data and the speed data of the measured value dataset, (ii) forming an output dataset based on the tire data of the measured value dataset, and (iii) training the AI module based on the modified training dataset.

The present invention relates to a computer-implemented method for training an artificial intelligence module to determine a tire type of a motor vehicle, a computer program, a sensor system for a motor vehicle, and a motor vehicle.

### PRIOR ART

In the field of automotive sensor technology, a large number of sensors and sensor systems are known which are used to detect road conditions or the friction coefficient. A factor here is the type of tire used, for example summer or winter tires.

US 2012/0207340 A1 discloses a method for distinguishing tire types on the basis of image data.

### DISCLOSURE OF THE INVENTION

With embodiments of the invention, an improved computer-implemented method for training an artificial intelligence (AI) module to determine a tire type of a motor vehicle can advantageously be provided.

The invention is defined in the independent claims. Advantageous developments of the invention result from the dependent claims and the following description. Technical terms are used in the usual manner. When a particular meaning is given to a particular term, definitions thereof are given below, within the scope of which the terms are used.

One aspect of the invention relates to a computer-implemented method for training an AI module to determine a tire type of a motor vehicle, comprising the steps of:
providing, on a data carrier, a measured value dataset, the measured value dataset comprising at least one data entry regarding ultrasound data, speed data, and tire data, the ultrasound data describing at least one ultrasonic wave that was produced by a rolling of a tire of the motor vehicle, the speed data describing a speed of the motor vehicle, the tire data describing a tire type of the motor vehicle,
generating a training dataset based on the measured value dataset, the generation of the training dataset comprising the steps of:
   forming an input dataset based on the ultrasound data and the speed data of the measured value dataset,
   forming an output dataset based on the tire data of the measured value dataset,
training the AI module based on the training dataset.

An advantage of this embodiment can be that with the aid of the AI module, existing sensors on a motor vehicle can be used in order to detect the type of tire. For example, an ultrasonic sensor, such as a parking ultrasonic sensor, which is connected by means of an AI module, can be used for this purpose. Here the AI module can evaluate the ultrasonic signals of the ultrasonic sensor in such a way that a tire type, such as winter or summer tires of the motor vehicle, can be detected. This can be advantageous in particular in the case of autonomously driving motor vehicles, so that improved control and regulation of the motor vehicle can take place.

The AI module can be any processor or computer that is configured to run an artificial intelligence, machine learning, or deep learning approach. Furthermore, the method comprises the step of providing, downloading and/or querying, on a storage medium or database, a measured value dataset, the measured value dataset comprising at least one data entry about ultrasound data, speed data and tire data. Thus, a measured value dataset can be queried or provided which has data about a motor vehicle, in particular the data of an ultrasonic sensor of the motor vehicle, the speed data of the motor vehicle, and the tire data of the motor vehicle. Furthermore, the ultrasound data can describe, represent and/or store at least one ultrasonic wave. In particular, the ultrasonic wave is an ultrasonic wave that has been recorded by means of an ultrasonic sensor and converted into a signal for data processing. The ultrasonic wave can be formed by rolling a tire of the motor vehicle, in particular on a ground surface. In particular, the ultrasonic wave can have been recorded in a frequency range of 40 kHz to 60 kHz, further 45 kHz to 54 kHz, by means of an ultrasonic sensor. Furthermore, the speed data can describe or represent a speed of the motor vehicle. The speed data is, for example, a speed of the motor vehicle in kilometers per hour. Furthermore, the tire data can describe and/or store a tire type such as, for example, summer tires or winter tires of the motor vehicle. Other types of tires, such as tires with spikes or the like, can also be used as the tire type of the motor vehicle. Thus, all types of tires of motor vehicles are included. Furthermore, here the method may include the step of generating, calculating, and/or creating a training dataset based on the measured value dataset. A training dataset is a type of dataset or a plurality of data entries which can be used to train an artificial intelligence or an AI module. The generation of the training dataset can further comprise forming, calculating and/or determining an input dataset based on the ultrasound data and the speed data of the measured value dataset. Furthermore, the measured value dataset can also have further data entries, such as acceleration data and/or braking data, which describe acceleration and/or braking values of the motor vehicle. The training dataset can thus also be formed with the aid of the additional acceleration data and/or braking data. The measured value dataset can moreover comprise data and/or data entries which describe the driving dynamics of the motor vehicle. Furthermore, the input dataset is data which can be loaded onto an input layer of an AI module.

The generation of the training dataset further comprises the step of forming, calculating and/or shaping an output dataset based on the tire data of the measured value dataset. Here, the output dataset can be a dataset that can be loaded onto the output layers of an AI module or machine learning approach. The tire data can be, for example, summer tires and/or winter tires. In addition, the method has the step of training the AI module based on the training dataset. Training means here that the AI of the AI module is shaped, formed and/or calculated using the training dataset such that the ultrasound data and the speed data for the tire type can be correlated or networked. With the help of the trained AI module, software can be created to determine the tire type, which can be executed on a computing unit of, for example, an ultrasonic sensor or engine control device. Such software can apply the results of the trained AI module so that it cannot continue to learn, but requires significantly fewer resources. For example, the AI module or the AI of the AI module may be a recurrent neural network architecture, which has at least two layers. One of the two layers can be an input layer, which has a plurality of in particular 1 to 100 gated recurrent units. In addition, the AI can have an output layer that has at least one neuron, such as a Boolean output for a tire type. In addition, one or a plurality of hidden layers with gated recurrent units can optionally be provided. In one example, the speed data include speeds starting from approx. 40 km/h, so that a sufficient ultrasound signal or a signal which can be detected by an ultrasound sensor is present in the ultrasound data. Furthermore, the AI module can have a detection accuracy of at least 95% if it was trained with measured values that describe four cars for two months, in each case with one month of summer tires and one month of winter tires. In addition, the AI module can be constantly trained based on newly acquired data, so that an even better detection of the tire type can take place. In addition, an advantage of this embodiment can be that a very high reliability of the AI module can be achieved with the aid of a large number of parking sensors or ultrasonic sensors in a motor vehicle, because, for example, passing cars or the like can also be filtered out of the ultrasound data. Furthermore, the step of forming the training dataset can also take into account environmental influences, such as passing cars or trucks, construction work, weather, or tire pressures.

According to one embodiment, the generation of the training dataset further comprises:
rejecting data entries in the measured value dataset which exceed and/or fall below a predetermined limit value.

An advantage of this embodiment can be that defective measured values in the measured value dataset can already be rejected at an early stage of the method, so that the results of the AI module can be further improved. Another advantage of this embodiment may be that obvious erroneous measurements, which, such as starting an engine or the like, can be rejected from the measured value dataset, so that the reliability of the AI module or the training dataset can be further improved.

Furthermore, here rejecting, comparing against a limit value and/or pre-filtering of one or a plurality of data entries in the measured value dataset that exceed, fall below, or reach a predetermined limit value. In this case, the limit value may be known limits for ultrasonic or speed signals which are obviously associated with an erroneous measurement or a special condition, such as starting an engine or full braking. Furthermore, further data entries that do not fit into a predetermined training schedule can also be removed or rejected.

According to one embodiment, the generation of the training dataset further comprises:
downsampling/normalizing the ultrasound data, in particular to a frequency of approx. 1 kHz.

An advantage of this embodiment is that the ultrasound data, due to the downsampling or normalizing in particular to one hundred hertz, result in it being possible for the data size of the dataset to be significantly reduced.

The term downsampling is understood to mean the reduction of the support points in a time series, in particular of ultrasound data over time. Furthermore, here the downsampling or normalizing of the ultrasound data can take place at a targeted frequency, such as one hundred hertz. However, here the frequency can also be any other useful frequency between 1 and 1000 Hz.

According to one embodiment, the generation of the training dataset further comprises:
standardizing the ultrasound data and/or the speed data of the measured value dataset, in particular by removing the mean value and/or scaling to unit variance.

An advantage of this embodiment can be that a stability or efficiency of the learning process and/or training process of the AI module is improved with the aid of standardizing the ultrasound data and/or speed data.

Furthermore, standardizing, normalizing and/or matching the ultrasound data and/or the speed data of the measured value dataset can take place before or during the creation of the training dataset. The standardization can take place in particular by removing the mean value and/or scaling to unit variance of the ultrasound data and/or speed data.

According to one embodiment, the generation of the training dataset further comprises:
forming fractions of time-resolved ultrasound data and/or speed data for modeling time series, in particular a time window.

An advantage of this embodiment can be that through the formation of fractions, the training or learning of the AI module, in particular of a recurrent neural network, can be improved. In other words, fractions and/or batches of time-resolved data, in particular ultrasound data and/or speed data, can be formed, calculated and/or created for modeling time series. In particular an alternating time window or sliding time window can be created for modeling the time series, in particular based on the formed fractions of time-resolved ultrasound data and/or velocity data.

According to one embodiment, a duration of the fraction is 1 to 60 seconds.

An advantage of this embodiment can be that the fraction can be adapted to an available storage capacity, so that the possible applications of the method can be increased.

A duration of a fraction describes in particular a batch within a sliding time window. The duration can be between 1 and 60 seconds. In addition, however, any other duration can also be used that is configured or usable to set up a sliding time window on a programmable controller.

According to one embodiment, the generation of the training dataset further comprises:
comparing the speed data to a predetermined speed limit value,
rejecting data entries of the ultrasound data in the measured value dataset when the speed data, at the same time as the ultrasound data, reach, exceed or fall below the predetermined speed limit value.

An advantage of this embodiment can be that the speed data can be used to reject ultrasound data that are not relevant for training the AI module. For example, a limit value can be set to 40 kilometers per hour and all ultrasound data that have a corresponding speed value of below 40 km/h can be rejected. This can in particular have the advantage that the required storage capacity for training the AI module can be significantly reduced. Here, the speed data can be compared, calculated and/or determined for a predetermined speed limit value. Furthermore, all data entries of the ultrasound data in the measured value dataset can then be rejected, selected and/or filtered if the speed data reach, exceed and/or fall below the predetermined limit value at the same time as or simultaneously with the ultrasound data, or at the recording time of the ultrasound data.

A further aspect of the invention relates to a computer program which, when executed, instructs a processor to carry out steps of the method, as described above and below.

A further aspect relates to a sensor system for a motor vehicle, comprising:
at least one ultrasonic sensor, in particular a parking ultrasonic sensor,
an AI module which has been trained with the method as described above and below,
wherein the ultrasonic sensor is configured to detect an ultrasonic wave that was produced by rolling of a tire of a motor vehicle on a ground surface,
wherein the ultrasonic sensor is connected to the AI module, in particular by means of an Internet connection,
wherein the AI module is configured to determine a tire type of the tire of the motor vehicle on the basis of the ultrasonic wave detected by the ultrasonic sensor.

An advantage of this embodiment can be that the sensor system can access already-existing ultrasonic sensors, such as parking ultrasonic sensors, in a motor vehicle, so that there is an increase in the functionality of the ultrasonic sensors. Furthermore, costs can thereby be saved, since no further sensors are required for detecting the summer or winter tires.

The sensor system can be a central onboard sensor system or a decentralized sensor system. A central onboard sensor system can operate autonomously in a motor vehicle. The decentralized sensor system can have an ultrasonic sensor which is arranged in a motor vehicle, and the AI module is operated on a computer or server which is arranged outside the motor vehicle. Here, the AI module can be connected to the ultrasonic sensor in particular by means of an Internet connection or the like.

Another aspect of the invention is a motor vehicle having:
at least one tire,
a sensor system as described above and in the following, and/or
a computer-readable medium that stores a computer program as described above and below,
the sensor system being configured to determine a type of the at least one tire.

An advantage of this embodiment can be that an autonomous driving process can be improved with the aid of such a motor vehicle, because an improved analysis of the coefficient of friction can be carried out with the aid of the detection or determination of the type of the tire of the motor vehicle.

Elements and steps of the method, as described above and below, can be features and elements of the sensor system as described above and below, and/or of the motor vehicle as described above and below, and vice versa.

Further measures improving the invention are explained in more detail below, together with the description of the preferred embodiments of the invention, with reference to figures.

### EXEMPLARY EMBODIMENTS

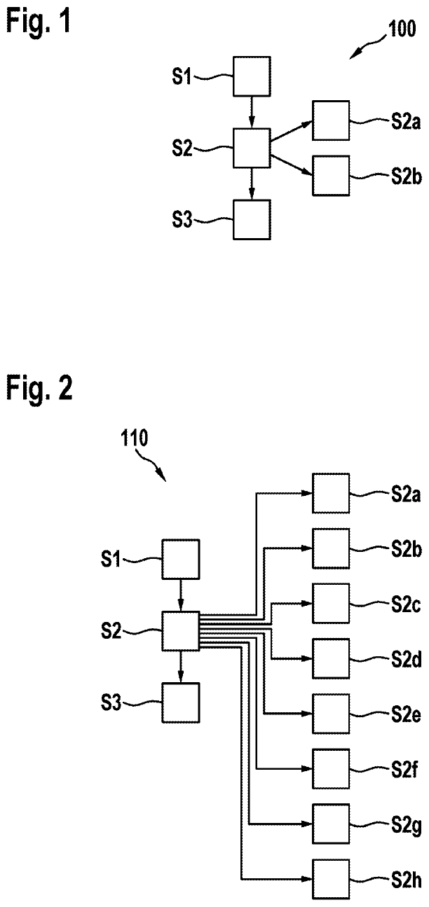

FIG. 1 shows a flow chart illustrating steps of the computer-implemented method according to one embodiment.

FIG. 2 shows a flow chart illustrating steps of the computer-implemented method according to one embodiment.

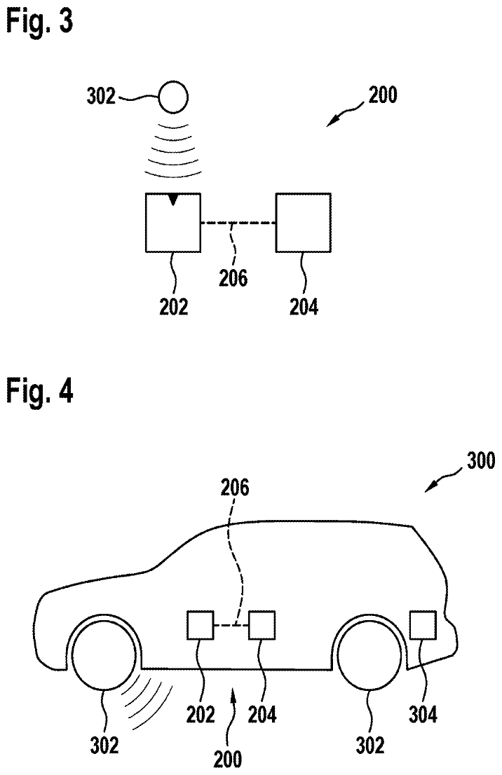

FIG. 3 shows a sensor system according to one embodiment.

FIG. 4 shows a motor vehicle according to one embodiment.

FIG. 1 shows a flow chart illustrating steps of the computer-implemented method 100 for training an AI module 204 to determine a tire type of a motor vehicle 300, comprising the steps of:
providing S1, on a data carrier, a measured value dataset, the measured value dataset comprising at least one data entry regarding ultrasound data, speed data, and tire data, the ultrasound data describing at least one ultrasonic wave that was produced by rolling of a tire 202 of the motor vehicle 300, the speed data describing a speed of the motor vehicle 300, the tire data describing a tire type of the motor vehicle 300,
generating S2 a training dataset based on the measured value dataset, the generation of the training dataset comprising the steps of:
   forming an input dataset S2a based on the ultrasound data and the speed data of the measured value dataset,
   forming an output dataset S2b based on the tire data of the measured value dataset,
training S3 of the AI module 204 based on the training dataset.

The advantage of this embodiment can be that with the aid of the method 100, already-existing ultrasonic sensors 202 can be used in a motor vehicle 300 in order to determine a type of a tire 302 of the motor vehicle 300.

Furthermore, the method can be carried out in the sequence as specified by the reference signs, or also in any other sequence. However, it should be particularly noted that steps S2a to S2h can be carried out in any sequence, in particular in any sequence that is technically expedient. In other words, using a dataset, for example consisting of ultrasound signals, speed, tire type, and additional optional information, such as the type of motor vehicle 300 and various environmental factors, such as passing vehicles, obstacles such as construction sites, or weather data and air pressure data, can be used to train an AI module 204. The dataset or the measurement data can be prepared with the method steps 2a to 2h before the model is trained.

FIG. 2 shows a flow chart illustrating steps of the further method 110. The further method 110 can have steps S1 to S3, as already explained with respect to FIG. 1. Furthermore, in the case of the expanded method 110, in step S2 a plurality of preparation steps for generating the training dataset can be combined. In this regard, step S2 can include steps S2a, forming an input dataset based on the ultrasound data and the speed data of the measured value dataset, and step S2b, forming an output dataset based on the tire data of the measured value dataset. Furthermore, step S2 of the expanded method 110 may include the step of rejecting S2c data entries in the measured value dataset that exceed or fall below a predetermined limit value. In addition, the method 110 has the step of downsampling/normalizing S2d the ultrasound data, in particular to a frequency of approx. 100 Hertz. Furthermore, step S2 of the further method 110 may include the step of standardizing S2e the ultrasound data and/or the speed data of the measured value dataset, in particular by removing the mean value and/or scaling to unit variance. Furthermore, the expanded method 110 may include the step of forming fractions S2f of time-resolved ultrasound data and/or speed data for modeling time series, in particular an alternating time window. Furthermore, the expanded method 110 may have the step of comparing S2g the speed data to a predetermined speed value. Furthermore, the expanded method 110 can include rejecting S2h data entries of the ultrasound data in the measured value dataset if the speed data, at the same time as the ultrasound data, reach, exceed, and/or fall below the predetermined limit value.

FIG. 3 shows a sensor system 200 which has an ultrasonic sensor 202 and an AI module 204. The AI module 204 can be connected to the ultrasonic sensor 202 by means of a connection, in particular an Internet connection 206. Furthermore, the AI module 204 can be connected to the ultrasonic sensor 202 with any other form of connection, in particular wired or wireless. The ultrasonic sensor 202 can detect an ultrasonic wave or other sound waves which result from the rolling of a tire 302.

FIG. 4 shows a motor vehicle 300. The motor vehicle 300 has a sensor system 200. The sensor system 200 has an ultrasonic sensor 202, which can in particular be a parking ultrasonic sensor of the motor vehicle 300, and an AI module 204. The AI module 204 can also be located outside the motor vehicle 300, for example on a server. The AI module 204 and the ultrasonic sensor 202 can be connected to one another by means of a connection 206, in particular by means of an Internet or wireless connection technology. Furthermore, the ultrasonic sensor 202 of the motor vehicle 300 can detect an ultrasonic wave or a sound wave resulting from a rolling of the tire 302 of the motor vehicle 300. Furthermore, the motor vehicle 300 can have a computer-readable medium 304 on which the AI module 204 or training datasets or a computer program can be stored. Furthermore, the motor vehicle 300 can have software which operates on the basis of the results of the AI module 204. This software can detect the tire type on the basis of the ultrasound data and the speed data, but the software cannot further improve the AI module 204. Furthermore, such software can be installed on a plurality of engine control devices in order to detect the tire type of motor vehicles 300, in particular independently of the model.

Additionally, it should be noted that “comprising” and “including” do not exclude other elements, and the indefinite articles “a” or “an” do not exclude a plurality. Furthermore, it should be noted that features that have been described with reference to any of the above embodiments may also be used in combination with other features of other embodiments described above. Reference signs in the claims are not to be considered as limiting.

1. A computer-implemented method for training an artificial intelligence module to determine a tire type of a motor vehicle, comprising:
providing, on a data carrier, a measured value dataset, wherein the measured value dataset comprises at least one data entry regarding ultrasound data, speed data, and tire data, wherein the ultrasound data describe at least one ultrasonic wave that was produced by rolling of a tire of the motor vehicle, wherein the speed data describe a speed of the motor vehicle, wherein the tire data describe a tire type of the motor vehicle, and
generating a modified training dataset based on the measured value dataset, wherein generating the modified training dataset comprises:
forming an input dataset based on the ultrasound data and the speed data of the measured value dataset,
forming an output dataset based on the tire data of the measured value dataset, and
training the AI module based on the modified training dataset.

2. The method according to claim 1, wherein generating the modified training dataset further comprises:
rejecting data entries in the measured value dataset which exceed and/or fall below a predetermined limit value.

3. The method according to claim 1, wherein generating the modified training dataset further comprises:
downsampling/normalizing the ultrasound data.

4. The method according to claim 1, wherein generating the modified training dataset further comprises:
standardizing the ultrasound data and/or the speed data of the measured value dataset.

5. The method according to claim 1, wherein generating the modified training dataset further comprises:
forming fractions of time-resolved ultrasound data and/or speed data for modeling time series.

6. The method according to claim 5, wherein a duration of the fraction is 1 to 60 seconds.

7. The method according to claim 1, wherein generating the modified training dataset further comprises:
comparing the speed data to a predetermined speed limit value, and
rejecting data entries of the ultrasound data in the initial training dataset when the speed data, at the same time as the ultrasound data, reach, exceed and/or fall below the predetermined speed limit value.

8. A computer program that, when executed, instructs a processor to carry out steps of the method according to claim 1.

9. A sensor system for a motor vehicle, comprising:
at least one ultrasonic sensor,
an AI module which has been trained with the method according to claim 1,
wherein the ultrasonic sensor is configured to detect an ultrasonic wave that was produced by rolling of a tire of a motor vehicle on a ground surface,
wherein the ultrasonic sensor is connected to the AI module, and
wherein the AI module is configured to determine a tire type of the tire of the motor vehicle on the basis of the ultrasonic wave detected by the ultrasonic sensor.

10. A motor vehicle, comprising:
at least one tire,
a sensor system according to claim 9, and/or
a computer-readable medium that stores a computer program according to claim 8,
wherein the sensor system is configured to determine a type of the at least one tire.

11. The method according to claim 1, wherein generating the modified training dataset further comprises:
downsampling/normalizing the ultrasound data to a frequency of approximately 100 Hz.

12. The method according to claim 1, wherein generating the modified training dataset further comprises:
standardizing the ultrasound data and/or the speed data of the measured value dataset by removing the average value and/or scaling to unit variance.

13. The method according to claim 1, wherein generating the modified training dataset further comprises:
forming fractions of time-resolved ultrasound data and/or speed data for modeling time series of a time window.

14. The sensor system according to claim 9, wherein:
the at least one ultrasonic sensor is a parking ultrasonic sensor, and
the ultrasonic sensor is connected to the AI module by way of an Internet connection.
